(19) United States
(12) Patent Application Publication
(10) Pub. No.: US 2013/0121890 A1
(43) Pub. Date: May 16, 2013

(54) PHOTOCATALYST-CONTAINING FILTER MATERIAL, AND PHOTOCATALYST FILTER INCLUDING THE FILTER MATERIAL

(71) Applicants: SAMSUNG ELECTRONICS CO., LTD., Suwon-si (KR); Photo & Environmental Technology Co., Gwangju (KR)

(72) Inventors: Jun-cheol BAE, Yongin (KR); Myong-jong Kwon, Suwon (KR); Sik-sun Choi, Osan (KR); Ki-yong Song, Seoul (KR); Joo-ho Kim, Suwon (KR); Kun-jung Kim, Seoul (KR); Jong-beom Kim, Gwangju (KR); Jong-ho Kim, Gwangju (KR); Ki-won Lee, Gwangju (KR); Byung-chul Choi, Gwangju (KR)

(73) Assignees: PHOTO & ENVIRONMENTAL TECHNOLOGY CO., Gwangju (KR); SAMSUNG ELECTRONICS CO., LTD., Suwon-si (KR)

(21) Appl. No.: 13/677,870

(22) Filed: Nov. 15, 2012

(30) Foreign Application Priority Data
Nov. 15, 2011 (KR) 10-2011-0119123

(51) Int. Cl. B01J 15/00

(52) U.S. Cl. 422/187

(57) ABSTRACT

A filter material containing a photocatalyst that has both adsorption and decomposition functions is disclosed. A filter employing the filter material is also disclosed.

### CROSS-REFERENCE TO RELATED APPLICATIONS

This application claims the benefit of Korean Patent Application No. 10-2011-0119123, filed on Nov. 15, 2011, in the Korean Intellectual Property Office, the disclosure of which is incorporated herein in its entirety by reference.

### BACKGROUND

1. Field

The present general inventive concept relates to a filter material, and more particularly, to a filter material including a photocatalyst, and a photocatalyst filter including the photocatalyst-containing filter material.

2. Description of the Related Art

Filter materials are used to remove unwanted harmful materials from fluid passed through the filter materials, for example, by adsorption or decomposition. For example, to clean up contaminated indoor air, an adsorbent such as activated carbon; an oxidization catalyst such as oxide manganese; or a photocatalyst such as titanium oxide may be used.

Photocatalysts may form electrons and holes when exposed to light having a larger energy than their own bandgap energy. These electrons and holes generate OH-radicals or O₂⁻ having high oxidizing power, which then decompose harmful substance.

Commonly available photocatalysts have a very slow decomposition rate with respect to harmful substance. Thus, when used in an air cleaner with a high air flow rate, a photocatalyst is not likely to effectively decompose harmful substance.

### SUMMARY

Additional aspects and/or advantages will be set forth in part in the description which follows and, in part, will be apparent from the description, or may be learned by practice of the invention.

The present disclosure provides a filter material containing a photocatalyst that has both adsorption and decomposition functions. The present disclosure provides a filter using the filter material.

According to an aspect, there is provided a filter material including a titania nanotube, zeolite, and a binder.

The titania nanotube may be obtained by subjecting titania powder to a hydro-thermal process using an alkali solution, an acid treatment, and calcination.

The zeolite may be a mordenite framework inverted (MFI)-type zeolite.

The zeolite may have a Si/Al mole ratio of from about 20 to about 100.

The binder may be bentonite, alumina, silica, apatite, or a combination thereof.

The filter material may be a layered filter material including a plurality of layers with different content ratios of the titania nanotube to the zeolite.

According to another aspect, there is provided a filter including a filter support and a filter material layer coated on a surface of the filter support, wherein the filter material layer includes a titania nanotube, zeolite, and a binder.

According to another aspect, there is provided a filter including a filter support and a filter material layer coated on a surface of the filter support, wherein the filter material layer includes a first coating layer on the surface of the filter support, and a second coating layer on an external surface of the first coating layer, the first coating layer including zeolite and a binder, and the second coating layer including a titania nanotube and a binder.

The filter support may be a cordierite that is a porous support.

### BRIEF DESCRIPTION OF THE DRAWINGS

The above and other features and advantages of the present general inventive concept will become more apparent by describing in detail exemplary embodiments thereof with reference to the attached drawings in which:

FIG. 1 is a graph showing X-ray diffraction (XRD) patterns of titania (P-25) as a start material, the K-TNT of Preparation Example 1 (titanate nanotubes undergone through only the hydro-thermal process), the KH-TNT of Preparation Example 2 (titanate nanotubes undergone through the hydro-thermal process and acid washing), and the KH-TNT[600] of Preparation Example 3 (titanate nanotubes undergone through the hydro-thermal process, acid washing, and thermal treatment);

FIG. 2 is scanning electron microscopic (SEM) images of the titania (P-25) as a start material, K-TNT of Preparation Example 1, KH-TNT of Preparation Example 2, and KH-TNT[600] of Preparation Example 3;

FIG. 3 is a graph of results of an acetaldehyde adsorption/decomposition performance test on the titania (P-25) as a start material, the K-TNT of Preparation Example 1 (titanate nanotubes undergone through only the hydro-thermal process), and the KH-TNT of Preparation Example 2 (titanate nanotubes undergone through the hydro-thermal process and acid washing);

FIGS. 4A to 4D are SEM images of the KH-TNT of Preparation Example 2, KH-TNT[400] of Preparation Example 3, KH-TNT[500] of Preparation Example 4, and KH-TNT[600] Preparation Example 5, respectively;

FIGS. 5A, 5B, and 5C are SEM images of Co(0.1)KH-TNT of Preparation Example 6, (b) Cu(0.1)KH-TNT of Preparation Example 7, and Fe(0.1)KH-TNT of Preparation Example 8, respectively;

FIGS. 6 and 7 are graphs of results of an acetaldehyde adsorption/decomposition test on the KH-TNT of Preparation Example 2, Co(0.1)KH-TNT of Preparation Example 6, Cu(0.1)KH-TNT of Preparation Example 7, Fe(0.1)KH-TNT of Preparation Example 8, Mn(0.1)KH-TNT of Preparation Example 9, Co(0.1)KH-TNT[600] of Preparation Example 10, Cu(0.1)KH-TNT[600] of Preparation Example 11, Fe(0.1)KH-TNT[600] of Preparation Example 12, and Mn(0.1)KH-TNT[600] of Preparation Example 13;

FIGS. 8 and 9 show acetaldehyde adsorption performances of an MFI-type zeolite (available from PHOTO & ENVIRONMENTAL TECHNOLOGY Co. Ltd (www.pnekr.com) in Kwangjoo, Korea, Si/Al molar ratio=23.8, specific surface area=425 m²/g) and an FAU-type zeolite (available from Zeo Builder Co. Ltd. in Seoul Korea, Si/Al mole ratio=5, specific surface area=685 m²/g);

FIG. 10 is a graph of acetaldehyde adsorption performance of zeolite with a Si/Al mole ratio of 35, FIG. 11 is a graph of acetaldehyde adsorption performance of zeolite with a SI/Al mole ratio of 100, and FIG. 12 is a graph of acetaldehyde adsorption performance of zeolite with a Si/Al mole ratio of 200;

FIG. 13 is a graph of results of the acetaldehyde adsorption/decomposition performance test on a monolayered filter material of Example 1 and a multi-layered filter material of Example 2; and

FIG. 14 shows a photocatalyst filter of Example 4.

### DETAILED DESCRIPTION

The present disclosure will now be described more fully with reference to the accompanying drawings, in which exemplary embodiments of the present general inventive concept are shown.

According to an embodiment, there is provided a filter material including a titania nanotube, zeolite, and a binder.

Titania nanotubes (TNT) have a larger specific surface area than titania (TiO₂) photocatalysts, and have both photocatalytic and adsorbing functions. TNT may be able to adsorb an organic material in the air that the TNT contact. TNT may generate electrons and holes when exposed to light such as ultraviolet (UV) light that has a higher band-gap energy than that of the TNT. These electrons and holes generate OH-radicals or O₂⁻ having high oxidizing power, which then decompose an organic material. The organic material that is adsorbed on or contacts the TNT may be oxidized into a non-harmful material such as carbon dioxide due to a photocatalytic function of the TNT. The organic material adsorbed on the TNT may remain in strong contact with the TNT for a long time, and thus may be effectively oxidized photocatalytically by the TNT. This oxidation mechanism following adsorption may remarkably facilitate removal of the organic material by the TNT.

Zeolite is a kind of crystalline aminosilicate in which has nano-sized pores and channels are three-dimensionally arranged in a regular pattern. Zeolite has a very large specific surface area, and thus may function as an adsorbent. Zeolite may remove an organic material from the air by adsorption, in which an organic material physically adsorbed on the zeolite by weak force may be desorbed from the zeolite, and then re-adsorbed onto TNT due to the adsorbing function of the TNT. Since the zeolite and TNT are adjacent to each other, the organic material desorbed from the zeolite is likely to re-adsorb onto the TNT, rather than be in free form in the air. The organic material re-adsorbed onto the TNT is oxidized due to the photocatalytic function of the TNT.

The binder may bind the TNT and zeolite.

The TNT may be obtained by, for example, subjecting titania powder to a hydro-thermal process, an acid treatment process, and a calcination process.

The TNT powder may be anatase crystal, rutile crystal, and/or a mixture thereof. The TNT particles may be spherical.

The hydro-thermal process for synthesizing the TNT powder may involve heating the TNT powder in an alkaline aqueous solution. If the heating temperature is too low, the hydro-thermal process may not be effective, resulting with a reduced yield of TNT. If the heating temperature is too high, titania nanorods or nanowires, rather than TNT, may be formed. In some embodiments, the heating temperature may be from about 130° C. to about 190° C. If the heating time is too short, the hydro-thermal process may not be completed. The longer the heating time, the larger the yield of the hydro-thermal process may be. However, if the heating time is too long, the conversion rate of the hydro-thermal process may not increase any longer, thereby rather increasing manufacturing cost. In some embodiments, the heating time may be from about 30 hours to about 70 hours. The hydro-thermal process may be performed, for example, in an autoclave. An inner wall of the autoclave may have a lining of, for example, Teflon or nickel (Ni).

The alkaline aqueous solution may be, for example, a sodium hydroxide (NaOH) aqueous solution, a potassium hydroxide (KOH) aqueous solution, or a lithium hydroxide (LiOH) aqueous solution. If a concentration of the alkaline aqueous solution is too low, the yield of the TNT may be reduced. If the concentration of the alkaline aqueous solution is too high, due to oversaturation of alkaline ions at room temperature, a homogeneous aqueous solution may unlikely be obtained. In some embodiments, the alkaline aqueous solution may have a concentration of from about 7M to about 20M. In some other embodiments, the alkaline aqueous solution as a NaOH or LiOH aqueous solution may have a concentration of about 10M, and as a KOH aqueous solution may have a concentration of about 14M. In the hydro-thermal process, titania binds with metal ions in the alkaline aqueous solution, being converted into titanate in a nanotube structure. When a NaOH aqueous solution is used as the alkaline aqueous solution, titanate having a formula of NaₓTi_{y}O_{z} may result from the hydro-thermal process. When a KOH aqueous solution is used as the alkaline aqueous solution, titanate having a formula of KₓTi_{y}O_{z} may result from the hydro-thermal process. When a LiOH aqueous solution is used as the alkaline aqueous solution, titanate having a formula of LiₓTi_{y}O_{z} may result from the hydro-thermal process. When NaOH or KOH is used, multi-layered TNTs may be obtained.

The TNT prepared through the hydro-thermal process may be separated from the alkaline aqueous solution by, for example, filtration. The separated TNTs may be washed with distilled water to be neutral.

The titanate nanotubes obtained through the hydro-thermal process are subjected to the acid treatment process. In the acid treatment process, metal ions, for example, K, Na or Li ions, bound to the titanate nanotubes may be substituted with hydrogen ions.

An acid used in the acid treatment process may be, for example, a hydrogen chloride aqueous solution or a nitric acid aqueous solution. The acid treatment process may involve washing the titanate nanotubes obtained through the hydro-thermal process at least one time. In this acid-washing process, hydrogen ions in the acid aqueous solution may substitute metal ions of the titanate nanotubes, such as K, Na, or Li ions, resulting in hydrogen-bound TNTs. The hydrogen-bound titanate nanotubes are dried for example, at a temperature of about 110° C. for about 24 hours.

The titanate nanotubes prepared from the titania powder through the hydro-thermal process and acid treatment process may be represented by a formula of, for example, HₓTi_{y}O_{z}. In an embodiment, the titanate nanotubes may be represented as H₂Ti₃O₇.

The obtained titanate nanotubes may be calcinated at a temperature of, for example, from about 400° C. to about 700° C., thereby resulting in TNTs.

The zeolite may be, for example, mordenite framework inverted (MFR)-type zeolite, faujasite (FAU)-type zeolite, X-type zeolite, Y-type zeolite, or a mixture thereof. Zeolite with a hydrophilic surface is advantageous in adsorbing hydrophilic organic material. Zeolite with a hydrophobic surface is advantageous in adsorbing hydrophobic organic material. The larger a Si/Al mole ratio of zeolite, the stronger the hydrophobicity of the zeolite surface may become. For example, to adsorb a hydrophobic organic material such as acetaldehyde, the zeolite may have a Si/Al mole ratio of from about 20 to about 100.

The binder may be an inorganic binder, such as bentonite, alumina, silica, apatite, or a combination thereof.

In the filter material, when a content ratio of zeolite to titania nanotubes is too low, the adsorbing function of the filter material may deteriorate. On the other hand, when the content ratio of zeolite to titania nanotubes is too high, the decomposition function of the filter material may deteriorate. In some embodiments, the ratio of titania nanotubes to zeolite may be from about 3:7 to about 7:3 by weight.

The filter material is not specifically limited in shape and size. The filter material may have, for example, a spherical shape, a disc shape, or a rod shape. In some embodiments, the filter material may be a layered filter material having a plurality of layers with different content ratios of titania nanotubes to zeolite. For example, the filter material may be a layered filter material with first, second, and third layers, wherein the first and third layers each have a weight ratio of titania nanotubes to zeolite of from about 7:3 to about 5:5, and the second layer disposed between the first and third layers has a weight ratio of titania nanotubes to zeolite of from about 5:5 to about 3:7.

The filter material may be prepared by, for example, molding a slurry prepared by mixing the titania nanotubes, zeolite, binder, and water using a ball mill to obtain a molded product, and drying the molded product. The amount of the water may be, for example, from about 50 to about 150 parts by weight based on 100 parts by weight of a total amount of the titania nanotubes, zeolite, and binder. The drying temperature of the molded product may be, for example, from about 90° C. to about 200° C.

The filter material may be prepared by applying a spray sol obtained by mixing the titania nanotubes, zeolite, binder and water using a ball mill on a surface of the support, and drying the coated support to obtain the filter material in the form of a coating on the support. The amount of the water may be, for example, from about 50 to about 150 parts by weight based on 100 parts by weight of a total amount of the titania nanotubes, zeolite, and binder. The drying temperature of the coated support may be, for example, from about 300° C. to about 600° C.

According to another aspect, there is provided a filter including a filter support and a filter material layer coated on a surface of the filter support, wherein the filter material layer includes a titania nanotube, zeolite, and a binder. Non-limiting examples of the filter support are a metal form and a ceramic honeycomb. In some embodiments, cordierite used as a porous support may be used as the filter support.

According to another aspect, there is provided a filter including a filter support and a filter material layer coated on a surface of the filter support, wherein the filter material layer includes a first coating layer on the surface of the filter support, and a second coating layer on an external surface of the first coating layer, the first coating layer including zeolite and a binder and the second coating layer including a titania nanotube and a binder.

Non-limiting examples of the filter support are a metal form and a ceramic honeycomb. In some embodiments, cordierite used as a porous support may be used as the filter support.

### EXAMPLES

### Preparation Example 1

### Preparation of K-TNT

40 g of titania powder (Degussa P-25) and 450 g of a KOH aqueous solution (13N) were put into an autoclave installed with a Teflon container, and was subjected to a hydro-thermal process at about 140° C. for about 36 hours, thereby converting titania into titanate nanotubes. The titanate nanotubes were separated from the reaction mixture by filtration, and then washed with distilled water to be neutral (pH 7). The washed titanate nanotubes were dried at about 110° C. for 24 hours. The resulting titanate nanotubes were named “K-TNT”.

### Preparation Example 2

### Preparation of KH-TNT

40 g of titania powder (Degussa P-25) and 450 g of a KOH aqueous solution (13N) were put into an autoclave installed with a Teflon container, and was subjected to a hydro-thermal process at about 140° C. for about 36 hours, thereby converting titania into titanate nanotubes. The titanate nanotubes were separated from the reaction mixture by filtration, and then washed with distilled water to be neutral (pH 7). The washed titanate nanotubes were further washed with an acid solution (35 wt % HCl aqueous solution) five times for ion exchange by which K⁺ ions of the titanate nanotubes were changed to H⁺ ions. The ion-exchanged titanate nanotubes were dried at about 110° C. for 24 hours. The resulting titanate nanotubes were named “KH-TNT”.

### Preparation Example 3

### Preparation of KH-TNT[400]

The KH-TNT obtained in Prepared Example 2 was thermally treated in an electric furnace at about 400° C. for about 4 hours. The thermally treated KH-TNT was named “KH-TNT[400]” , wherein “400” indicates the thermal treatment temperature.

### Preparation Example 4

### Preparation of KH-TNT[500]

The KH-TNT obtained in Prepared Example 2 was thermally treated in an electric furnace at about 500° C. for about 4 hours. The thermally treated KH-TNT was named “KH-TNT[500]”, wherein “500” indicates the thermal treatment temperature.

### Preparation Example 5

### Preparation of KH-TNT[600]

The KH-TNT obtained in Prepared Example 2 was thermally treated in an electric furnace at about 500° C. for about 4 hours. The thermally treated KH-TNT was named “KH-TNT[600]”, wherein “600” indicates the thermal treatment temperature.

### Preparation Example 6

### Preparation of Co(0.1)KH-TNT

40 g of the KH-TNT obtained in Preparation Example 2 was added to 450 g of a 0.1 M CoNO₃ aqueous solution to obtain a mixture of the KH-TNT and CoNO₂ aqueous solution, was stirred for about 6 hours so that Co was supported by the KH-TNT. The Co-supported KH-TNT was separated from the mixture by filtration, and then, dried at about at about 110° C. for 24 hours. The resulting Co-supported KH-TNT was named “Co(0.1)KH-TNT”, wherein “0.1” indicates the concentration of the CoNO₃ aqueous solution.

### Preparation Example 7

### Preparation of Cu(0.1)KH-TNT

Cu-supported KH-TNT was obtained in the same manner as in Preparation Example 6, except that a 0.1 M CuNO₃ aqueous solution was used instead of the 0.1 M CoNO₃ aqueous solution.

### Preparation Example 8

### Preparation of Fe(0.1)KH-TNT

Fe-supported KH-TNT was obtained in the same manner as in Preparation Example 6, except that a 0.1M FeNO₃ aqueous solution was used instead of the 0.1M CoNO₃ aqueous solution.

### Preparation Example 9

### Preparation of Mn(0.1)KH-TNT

Mn-supported KH-TNT was obtained in the same manner as in Preparation Example 6, except that a 0.1M MnNO₃ aqueous solution was used instead of the 0.1M CoNO₃ aqueous solution.

### Preparation Example 10

### Preparation of Co(0.1)KH-TNT[600]

The Co(0.1)KH-TNT obtained in Preparation Example 6 was thermally treated in an electric furnace at about 600° C. for about 4 hours, thereby preparing Co(0.1)KH-TNT[600].

### Preparation Example 11

### Preparation of Co(0.1)KH-TNT[600]

The Cu(0.1)KH-TNT obtained in Preparation Example 7 was thermally treated in an electric furnace at about 600° C. for about 4 hours, thereby preparing Cu(0.1)KH-TNT[600].

### Preparation Example 12

### Preparation of Fe(0.1)KH-TNT[600]

The Fe(0.1)KH-TNT obtained in Preparation Example 8 was thermally treated in an electric furnace at about 600° C. for about 4 hours, thereby preparing Fe(0.1)KH-TNT[600].

### Preparation Example 13

### Preparation of Mn(0.1)KH-TNT[600]

The Mn(0.1)KH-TNT obtained in Preparation Example 9 was thermally treated in an electric furnace at about 600° C. for about 4 hours, thereby preparing Mn(0.1)KH-TNT[600].

### Example 1

### Preparation of Filter Material

20 g of the KH-TNT obtained in Preparation Example 2, 20 g of an MFI-type zeolite (available from PHOTO & ENVIRONMENTAL TECHNOLOGY Co. Ltd., Si/Al mole ratio=23.8), and 4 g of bentonite (available from SUD-CHEMIE Korea Co., Ltd) were mixed using a ball mill for about 24 hours. 40 g of the resulting mixture was press-molded in a circular disc shape (having a diameter of about 10 mm and a thickness of about 3 mm). The resulting circular disc-shaped material was used a filter material of Example 1.

### Example 2

### Preparation of Layered Filter Material

In Example 2, a layered filter material with three stacked disc-shaped materials was prepared.

28 g of the KH-TNT obtained in Preparation Example 2, 12 g of an MFI-type zeolite (available from PHOTO & ENVIRONMENTAL TECHNOLOGY Co. Ltd., Si/Al mole ratio=23.8), and 4 g of bentonite (available from SUD-CHEMIE Korea Co., Ltd) were mixed using a ball mill for about 24 hours. 40 g of the resulting mixture was press-molded in a circular disc shape (having a diameter of about 10 mm and a thickness of about 3 mm). The resulting circular disc-shaped material was named a first disc.

12 g of the KH-TNT obtained in Preparation Example 2, 28 g of an MFI-type zeolite (available from PHOTO & ENVIRONMENTAL TECHNOLOGY Co. Ltd., Si/Al mole ratio=23.8), and 4 g of bentonite (available from SUD-CHEMIE Korea Co., Ltd) were mixed using a ball mill for about 24 hours. 40 g of the resulting mixture was press-molded in a circular disc shape (having a diameter of about 10 mm and a thickness of about 3 mm). The resulting circular disc-shaped material was named a second disc.

28 g of the KH-TNT obtained in Preparation Example 2, 12 g of an MFI-type zeolite (available from PHOTO & ENVIRONMENTAL TECHNOLOGY Co. Ltd., Si/Al mole ratio=23.8), and 4 g of bentonite (available from SUD-CHEMIE Korea Co., Ltd) were mixed using a ball mill for about 24 hours. 40 g of the resulting mixture was press-molded in a circular disc shape (having a diameter of about 10 mm and a thickness of about 3 mm). The resulting circular disc-shaped material was named a third disc.

These first, second, and third discs were press-molded into one disc, which was used as the layered filter material of Example 2 (having a thickness of about 3 mm, a diameter of about 10 mm, and a weight of about 0.38 g). In the layered filter material the first disc had a weight ratio of KH-TNT to MFI-type zeolite of about 7:3, the second disc had a weight ratio of KH-TNT to MFI-type zeolite of about 3:7, and the third disc had a weight ratio of KH-TNT to MFI-type zeolite of about 7:3.

### Example 3

### Manufacture of Filter

A plastic lattice with horizontally linked vertical cylinders each having a diameter of about 15 mm and a height of about 15 mm was used as a filter support. Two of the filter materials of Example 2 were inserted into each of the cylinders of the filter support, followed by attaching a meshed cloth to each opposing side of the filter support, thereby completing manufacture of a filter having a dimension of 340 mm×340 mm×15 mm.

### Example 4

### Manufacture of Filter

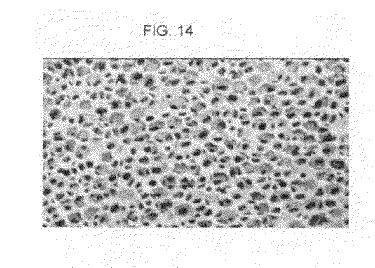

40 g of the KH-TNT obtained in Preparation Example 2, 40 g of an MFI-type zeolite (available from PHOTO & ENVIRONMENTAL TECHNOLOGY Co. Ltd., Si/Al mole ratio=23.8), 400 g of a titanium-based binder (HT-1, available from PHOTO & ENVIRONMENTAL TECHNOLOGY Co. Ltd.) and a solvent (ethanol) were mixed together to prepare a spray sol. This spray sol was coated on 3-dimensional porous cordierite (available from DAESAN CHEMICALS CO.) having a size of 340 mm×340 mm×15 mm with a spray coater, and then was thermally treated at about 500° C. for about 6 hours, thereby manufacturing a photocatalyst catalyst of FIG. 14.

### Example 5

### Manufacture of Filter

40 g of an MFI-type zeolite (available from PHOTO & ENVIRONMENTAL TECHNOLOGY Co. Ltd., Si/Al mole ratio=23.8), 400 g of a titanium-based binder (HT-1, available from PHOTO & ENVIRONMENTAL TECHNOLOGY Co. Ltd.) and a solvent (ethanol) were mixed together to prepare a spray sol for a first coating layer.

40 g of the KH-TNT obtained in Preparation Example 2, 400 g of a titanium-based binder (HT-1, available from PHOTO & ENVIRONMENTAL TECHNOLOGY Co. Ltd.) and a solvent (ethanol) were mixed together to prepare a spray sol for a second coating layer.

The spray sol for the first coating layer was coated on 3-dimensional porous cordierite (available from DAESAN CHEMICALS CO.) having a size of 340 mm×340 mm×15 mm with a spray coater, and then was thermally treated at about 500° C. for about 6 hours.

Subsequently, the spray sol for the second coating layer was coated on the cordierite with the first coating layer using a spray coater, and then was thermally treated at about 500° C. for about 6 hours, thereby manufacturing a filter of Example 5.

### Comparative Example 1

### Manufacture of Filter

A filter was manufactured in the same manner as in Example 4, except that titania (P-25) was used instead of the KH-TNT obtained in Preparation Example 2.

### <Evaluation Methods>

### (1) X-Ray Diffraction (XRD) Analysis

X-ray diffraction patterns were observed at 40 kA and 40 mA using an X-ray diffractometer (available from Rigaku, D/MAX Uitima III) using CuKa1 X-ray (λ=1.54056 Å) and a Ni-filter, at a rate of 2°/min with a 2θ range of 5˜90°.

### (2) Scanning Electron Microscopic (SEM) Analysis

A scanning electron microscope (Hitachi S-4700) was used. Element contents in each sample were measured using an energy dispersive X-ray spectrometer (EDA, Horiba EX-250) equipped on the scanning electron microscope.

### (3) Measurement of Nitrogen Adsorption Isotherm

Nitrogen adsorption isotherms were obtained using an automatic volumetric adsorption measuring apparatus (Mirae SI nanoPorosity-XG). After evacuation at about 300° C. for about 1 hour, nitrogen adsorption/desorption isotherms were recorded at a liquid nitrogen temperature (77K). A specific surface area of each sample was calculated using the BET equation.

### (4) Acetaldehyde Adsorption/Decomposition Performance Test

Acetaldehyde adsorption/decomposition performance was tested using a reactor (220×125×80 mm) and a gas chromatograph (GC, HP-5900). The reactor was equipped with a UV lamp, and the GC was equipped with a flame ionization detector (FID) and a HP-5 column. The GC operating conditions were as follows: temperatures of the injection portion and detector were set to about 250° C., and oven temperature was increased from about 40° C. to about 60° C. at 5° C./min and to about 100° C. at 2° C./min. A petri dish spread with 0.5 g of a sample (for example, a photocatalyst) was placed in the reactor, and then 2,000 ppm of acetaldehyde (Fox-chemicals, 99.9%) was injected into the reactor. Then, a concentration change of aldehyde in the air in the reactor with respect to time was measured using the GC. Adsorption performance was measured with the UV lamp turned off until the acetaldehyde concentration in the reaction reduced no longer (for about 1 hour). Decomposition performance was measured after the adsorption test with the UV lamp turned on for about 200 minutes.

### (5) Chamber Test

The inside of an air cleaner (HC-M530R, Samsung Electronics) was altered so as to install a photocatalyst filter (exterior dimensions: 340×340×15 mm) thereto, and then was equipped with the photocatalyst filter and two UV lamps (8 W). A chamber test was performed using the California (CA)-standard chamber test method (Indoor Air Cleaner Inspection Standard SPS-KACA002-132). Ammonia, acetaldehyde, and citric acid were used as test gases. The chamber accommodating the air cleaner had a volume of 4 m³. An initial concentration of each test gas in the chamber was about 10 ppm. The operating time of the air cleaner in the chamber was about 30 minutes. Gases in the chamber were analyzed using Fourier-Transform Infrared (FT-IR) spectroscopy.

### <Evaluation Results>

### (1) Characteristic Comparison Among Titania (P-25), K-TNT, and KH-TNT

### Crystal Structure and Particle Shape

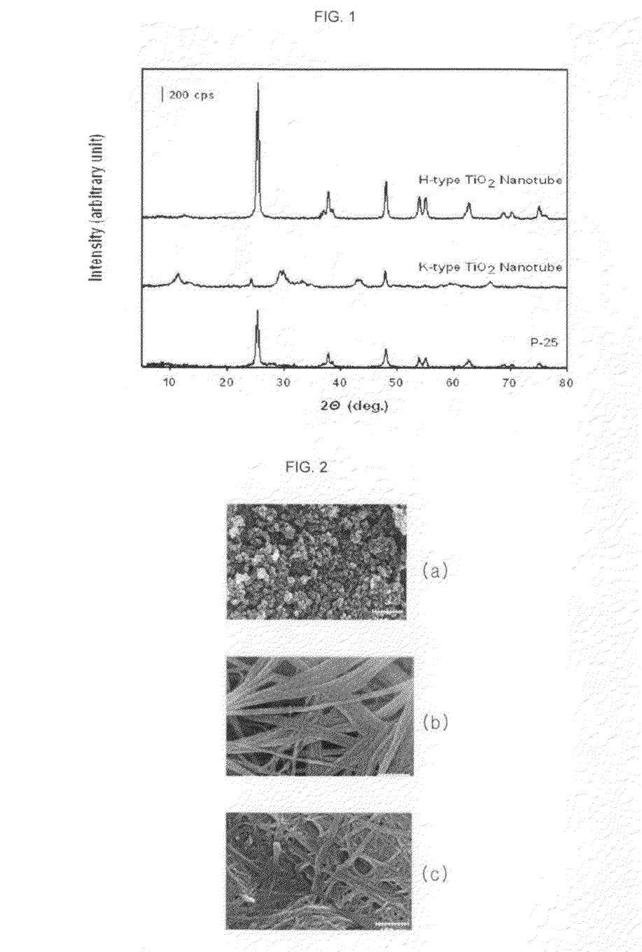

XRD analysis results of titania (P-25) as a start material, the K-TNT of Preparation Example 1 (titanate nanotubes that underwent through only the hydro-thermal process), the KH-TNT of Preparation Example 2 (titanate nanotubes undergone through the hydro-thermal process and acid washing), and the KH-TNT[600] of Preparation Example 3 (titanate nanotubes undergone through the hydro-thermal process, acid washing, and thermal treatment) are shown in FIG. 1.

Referring to FIG. 1, as widely known, the titania (P-25) was a mixture of anatase crystals and rutile crystals. The K-TNT was found to have a titanate crystal structure. In the hydro-thermal process using the KOH aqueous solution, the crystalline structure of the titania seems to have been broken by a strong base and underwent self-assembling through reaction with potassium (K). This self-assembling of the titania is considered to form the titanate crystal structure.

During the heat treatment process, the titanate crystal structure of KH-TNT[600] was broken by heat, then, KH-TNT[600] returned to the anatase crystal structure.

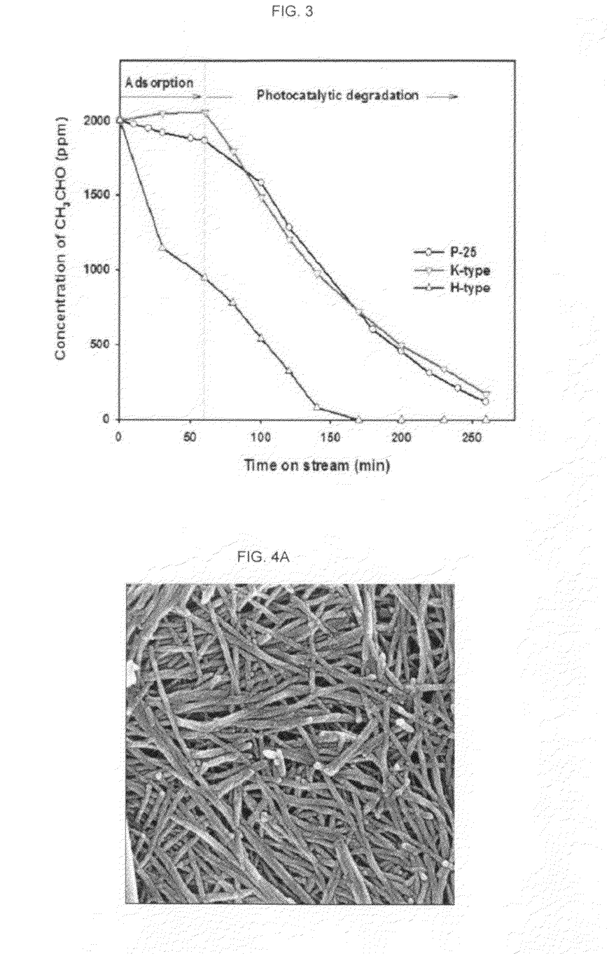

SEM images of the titania (P-25) as a start material, K-TNT of Preparation Example 1, KH-TNT of Preparation Example 2, and KH-TNT[600] of Preparation Example 3 are shown in FIG. 2. FIG. 2, (a), (b), and (c) show particle shapes of the titania (P-25), K-TNT of Preparation Example 1, and KH-TNT of Preparation Example 2, respectively.

The titania (P-25) had a spherical particle shape with a particle size of from about 30 nm to about 40 nm. The K-TNT particles of Preparation Example 1 obtained through the hydro-thermal process were in long fibrous nanotubes having a diameter of about 20 nm.

The KH-TNT[600] particles of Preparation Example 3 were in short fibrous nanotubes. This is attributed to cutting of long fibrous nanotubes through the acid treatment and calcination process, into the short fibrous nanotubes with an open end.

### Specific Surface Area

Specific surface areas of the titania (P-25) as a start material, the K-TNT of Preparation Example 1 (titanate nanotubes undergone through only the hydro-thermal process), the KH-TNT of Preparation Example 2 (titanate nanotubes undergone through the hydro-thermal process and acid washing), and the KH-TNT[600] of Preparation Example 3 (titanate nanotubes undergone through the hydro-thermal process, acid washing, and thermal treatment) were calculated from results of the nitrogen adsorption isotherm analysis.

The titania (P-25) had a specific surface area of about 60.15 m²/g, the K-TNT of Preparation Example 1 had a specific surface area of about 242.85 m²/g, and the KH-TNT of Preparation Example 2 had a specific surface area of about 328.71 m²/g. This indicates that the KH-TNT of Preparation Example 2 has a specific surface area that is about 5 times larger than that of the titania (P-25).

### (2) Acetaldehyde Adsorption/Decomposition Performance

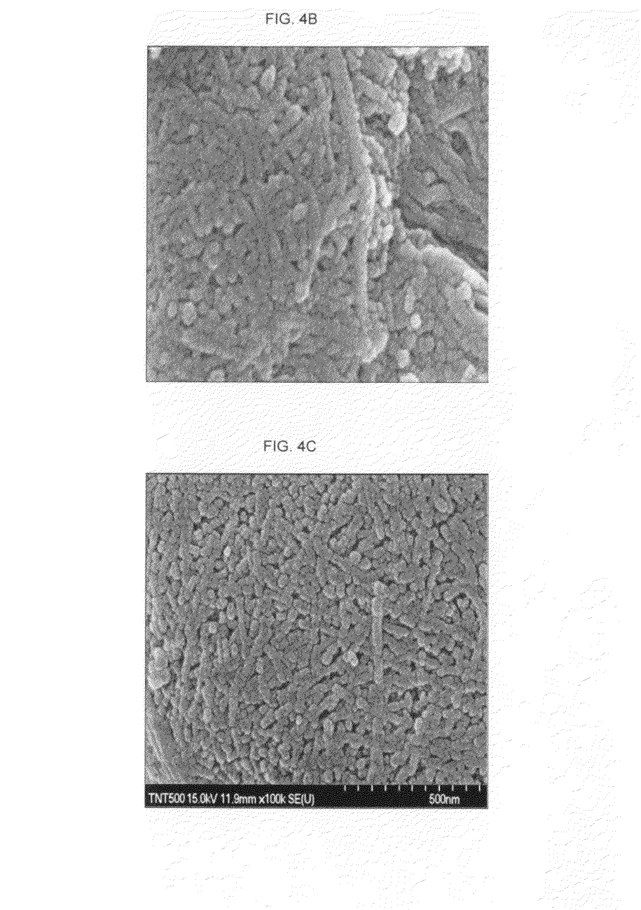

Results of the acetaldehyde adsorption/decomposition performance test on the titania (P-25) as a start material, the K-TNT of Preparation Example 1 (titanate nanotubes undergone through only the hydro-thermal process), and the KH-TNT of Preparation Example 2 (titanate nanotubes undergone through the hydro-thermal process and acid washing) are shown in FIG. 3.

Adsorption performance of the titania (P-25) was insignificant. Even with a much larger specific surface area than the titania (P-25), the K-TNT of Preparation Example 1 exhibited no adsorption performance. The KH-TNT of Preparation Example 2 exhibited significantly improved adsorption performance. The KH-TNT of Preparation Example 2 also exhibited significantly better decomposition performance than the titania (P-25) and K-TNT.

(3) Characteristic Changes in KH-TNT with Respect to Calcination (Thermal Treatment) Temperature

### Particle Shape

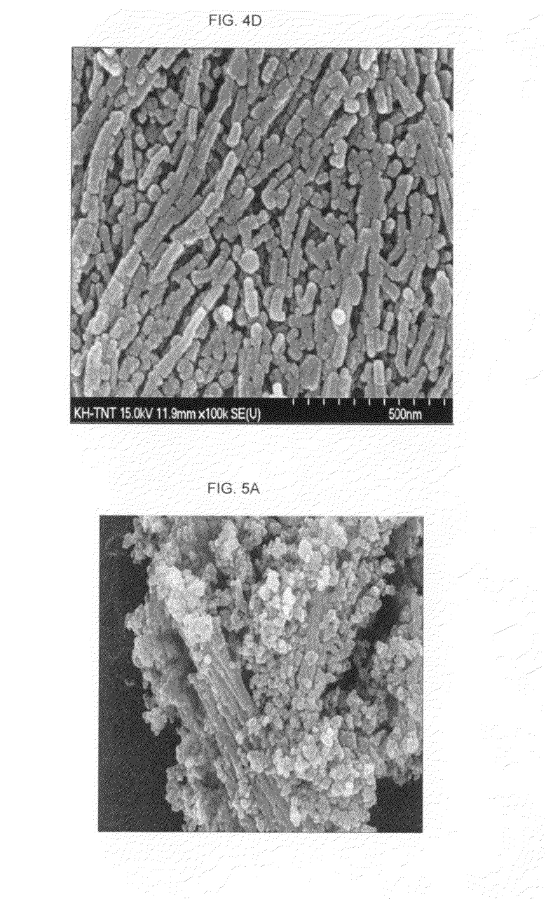

SEM images of the KH-TNT of Preparation Example 2, KH-TNT[400] of Preparation Example 3, KH-TNT[500] of Preparation Example 4, and KH-TNT[600] Preparation Example 5 are shown in FIG. 4. In FIG. 4, (a), (b), (c), and (d) show the KH-TNT of Preparation Example 2, KH-TNT[400] of Preparation Example 3, KH-TNT[500] of Preparation Example 4, and KH-TNT[600] of Preparation Example 5, respectively.

The KH-TNT of Preparation Example 2 undergone only drying at about 110° C. had a well-developed long fibrous shape. The KH-TNT[400] of Preparation Example 3, KH-TNT[500] of Preparation Example 4, and KH-TNT[600] of Preparation Example 5, which were calcinated at about 400° C. or higher, had short fibrous shapes. That is, the long fibrous shape was changed to the short fibrous shape through calcination. The higher the calcination temperature became, the more predominant the short fibrous shape was. The calcination seems to be attributed to the change of the titanate structure into the stable titania crystal structure.

### Specific Surface Area

Specific surface areas were calculated from results of the nitrogen adsorption isotherm analysis on the KH-TNT of Preparation Example 2, KH-TNT[500] of Preparation Example 4, and KH-TNT[600] of Preparation Example 5.

The KH-TNT of Preparation Example 2 that had not underdone the calcination had a specific surface area of about 326.57 m²/g, KH-TNT[500] of Preparation Example 4 that calcinated at about 500° C. had a specific surface area of about 119 m²/g, and KH-TNT[600] of Preparation Example 5 that calcinated at about 600° C. had a specific surface area of about 68.41 m²/g. The higher the calcination temperature became, the specific surface area was much significantly reduced. This is due to a change of nanotubes to nanorods through the calcination.

### (4) Effect of Loading of Transition Metal

### Particle Shape

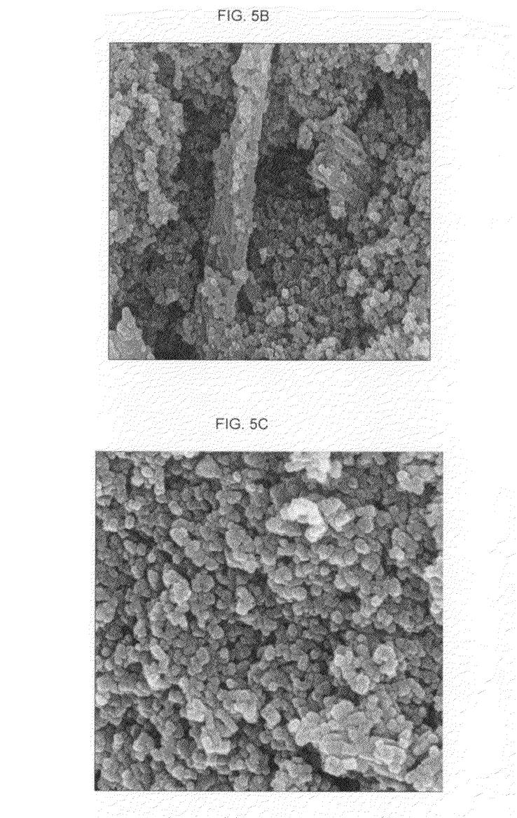

In FIGS. 5A, 5B, and 5C are SEM images of Co(0.1)KH-TNT of Preparation Example 6, Cu(0.1)KH-TNT of Preparation Example 7, and Fe(0.1)KH-TNT of Preparation Example 8, respectively. As can be seen in FIG. 5, transition metal particles were bound to an external surface of the nanotubes. In particular, the shapes of nanotubes were changed to short fibrous shape when loaded with Cu or Fe particles.

### EDX Analysis

Results of the EDX analysis on the KH-TNT of Preparation Example 2, Co(0.1)KH-TNT of Preparation Example 6, Cu(0.1)KH-TNT of Preparation Example 7, and Fe(0.1)KH-TNT of Preparation Example 8 are presented in Tables 1, 2, 3, and 4, respectively, below. Compared with the results of Table 1, the results of Tables 2 to 4 indicate that these samples incorporated transition metals.

TABLE 1
KH-TNT of Preparation Example 2

| Element | Weight % | Atom % |
|---|---|---|
| C | 9.36 | 18.37 |
| O | 37.35 | 55.05 |
| Cl | 0.89 | 0.59 |
| K | 1.61 | 0.97 |
| Ti | 50.79 | 25.02 |
| Total | 100.00 | 100.00 |

TABLE 2
Co(0.1)KH-TNT of Preparation Example 6

| Element | Weight % | Atom % |
|---|---|---|
| C | 5.72 | 11.44 |
| O | 41.15 | 61.72 |
| Cl | 0.29 | 0.20 |
| K | 0.44 | 0.27 |
| Ti | 52.04 | 26.12 |
| Co | 0.36 | 0.25 |
| Total | 100.00 | 100.00 |

TABLE 3
Cu(0.1)KH-TNT of Preparation Example 7

| Element | Weight % | Atom % |
|---|---|---|
| C | 8.40 | 16.62 |
| O | 38.17 | 56.66 |
| Cl | 0.77 | 0.51 |
| K | 1.02 | 0.62 |
| Ti | 51.48 | 25.53 |
| Cu | 0.16 | 0.06 |
| Total | 100.00 | 100.00 |

TABLE 4
Fe(0.1)KH-TNT of Preparation Example 8

| Element | Weight % | Atom % |
|---|---|---|
| C | 13.34 | 23.40 |
| O | 43.89 | 57.78 |
| Cl | — | — |
| K | 0.28 | 0.15 |
| Ti | 42.23 | 18.57 |
| Fe | 0.26 | 0.10 |
| Total | 100.00 | 100.00 |

Acetaldehyde Adsorption/Decomposition Test

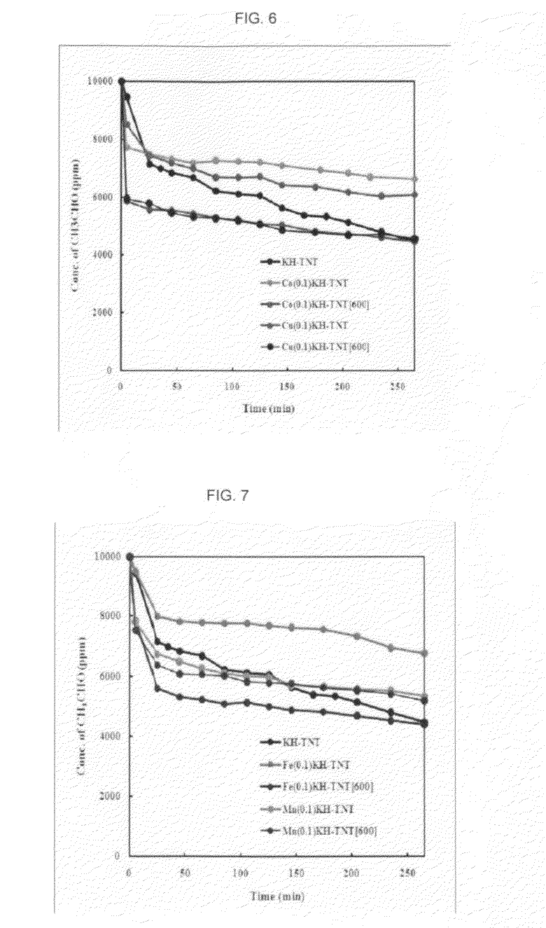

Results of the acetaldehyde adsorption/decomposition test on the KH-TNT of Preparation Example 2, Co(0.1)KH-TNT of Preparation Example 6, Cu(0.1)KH-TNT of Preparation Example 7, Fe(0.1)KH-TNT of Preparation Example 8, Mn(0.1)KH-TNT of Preparation Example 9, Co(0.1)KH-TNT[600] of Preparation Example 10, Cu(0.1)KH-TNT[600] of Preparation Example 11, Fe(0.1)KH-TNT[600] of Preparation Example 12, and Mn(0.1)KH-TNT[600] of Preparation Example 13 are shown in FIGS. 6 and 7.

Referring to FIGS. 6 and 7, the photocatalysts impregnated with transition metals had poor acetaldehyde adsorption/decomposition performance, as compared with the KH-TNT impregnated with no transition metal. This is attributed to the change of long fibrous nanotubes to relatively short ones during the transition metal incorporating process and to blocking of UV light from reaching the nanotubes by the transition metal, which leads to reduced photoactivity.

Remarkably, the adsorption performance was significantly better in the thermally heated TNT incorporated with transition metal than the TNT incorporated with transition metal but not thermally treated, and even better than in the KH-TNT incorporated with no transition metal.

### (5) Characteristics of Zeolite

### Acetaldehyde Adsorption Performance

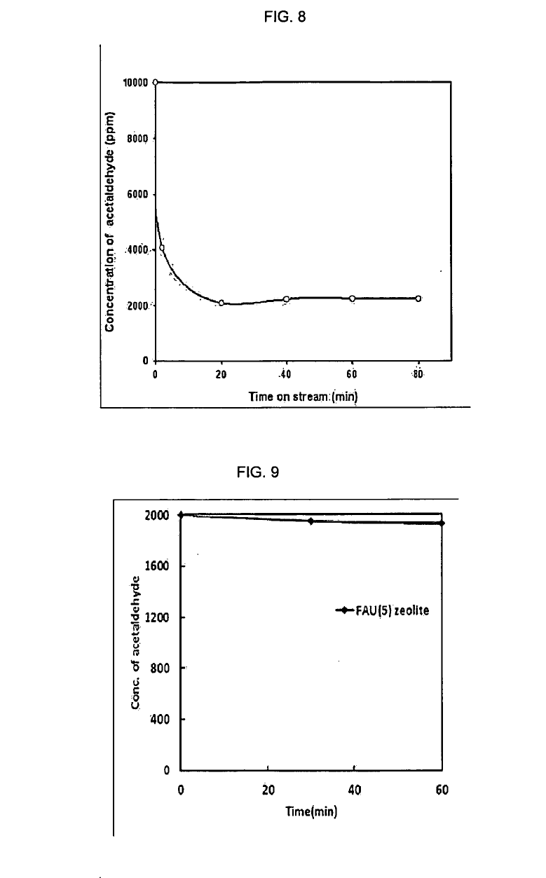

Results of acetaldehyde adsorption performance analysis on an MFI-type zeolite (available from PHOTO & ENVIRONMENTAL TECHNOLOGY Co. Ltd., Si/Al mole ratio=23.8, specific surface area=425 m²/g) and an FAU-type zeolite (available from Zeo Builder Co. Ltd., Si/Al mole ratio=5, specific surface area=685 m²/g) are shown in FIGS. 8 and 9, respectively. Referring to FIG. 8, the MFI zeolite was found to adsorb about 8,000 ppm of acetaldehyde within 20 minutes from the injection, which is equivalent to four fifth of the initial injection amount of acetaldehyde. Referring to FIG. 9, the FAU-type zeolite was found to have a very low acetaldehyde adsorption performance. Due to a low Si/Al mole ratio, the FAU-type zeolite has a hydrophilic surface, and nearly does not adsorb acetaldehyde as a hydrophobic organic material. These results indicate that hydrophobic zeolite is more effective than hydrophilic zeolite in adsorbing hydrophobic organic substances.

Acetaldehyde Adsorption Performance with Respect to Si/Al Mole Ratio

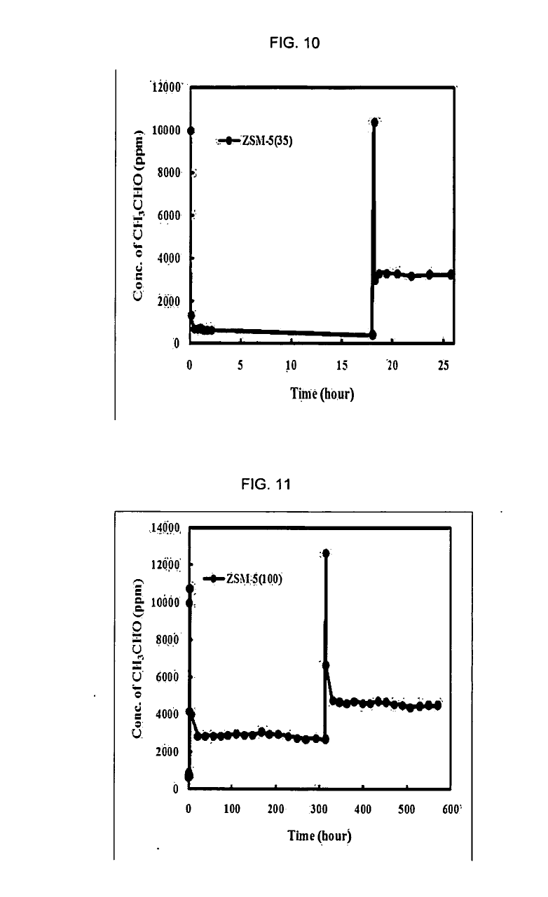

To investigate adsorption characteristics of zeolite with respect to Si/Al mole ratio, an experiment was conducted using AFI-type zeolites with different Si/Al mole ratios (available from COSMO FINE CHEMICALS, LTD.) The results are shown in FIGS. 10 to 12. FIG. 10 is a graph of acetaldehyde adsorption performance of zeolite with a Si/Al mole ratio of 35, FIG. 11 is a graph of acetaldehyde adsorption performance of zeolite with a SI/Al mole ratio of 100, and FIG. 12 is a graph of acetaldehyde adsorption performance of zeolite with a Si/Al mole ratio of 200. These three different zeolites had a specific surface area of about 390.42 m²/g, about 399.81 m²/g, and about 370.60 m²/g, respectively.

Referring to FIGS. 10 to 12, the zeolite with a Si/Al mole ratio of 35 adsorbed 16,800 ppm of acetaldehyde, the zeolite with a Si/Al mole ratio of 100 adsorbed 25,600 ppm of acetaldehyde, and the zeolite with a Si/Al mole ratio of 200 adsorbed 28,500 ppm of acetaldehyde. These three different zeolites were similar to one another in specific surface area, but significantly different from one another in acetaldehyde adsorption ability. As in the zeolite with a Si/Al mole ratio of 200, the weaker the acidity of zeolite, the more hydrophobic the zeolite surface, and the more the hydrophobic acetaldehyde is likely to be adsorbed. On the other hand, the smaller the Si/Al molar ratio of zeolite, the more an organic material with a hydrophilic group is likely to be adsorbed.

### (7) Performance of Filter Material

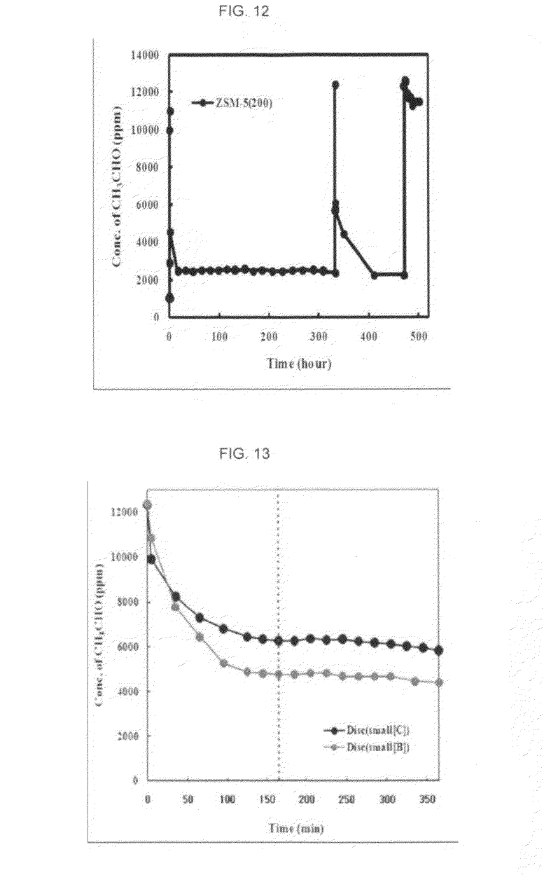

Results of the acetaldehyde adsorption/decomposition performance test on the monolayered filter material of Example 1 and the layered filter material of Example 2 are shown in FIG. 13. Referring to FIG. 13, the photocatalyst filter of Example 1 was found to have a higher adsorptivity and a lower photodecomposition rate than the photocatalyst filter of Example 2. These results are attributed to the amounts of TNT and zeolite exposed at the surface of each filter. The photocatalyst filter of Example 2 with more exposed TNT at the surface had a relatively high photodecomposition rate, while the photocatalyst filter of Example 1 with more exposed zeolite at the surface had a relatively high adsorptivity.

### (8) Chamber Test

A chamber test was performed on the filters of Examples 4 and 5 and Comparative Example 1. The results are shown in Table 5 below.

TABLE 5

| | | | | Comparative |
|---|---|---|---|---|
| | Test gas: | Example 4 | Example 5 | Example 1 |
| Removal efficiency | CH₃CHO | 40% | 75% | 5% |
| of first run | CH₃COOH | 100% | 100% | 100% |
| | NH₃ | 100% | 100% | 50% |
| removal efficiency | CH₃CHO | 40% | 70% | 4% |
| of second run | CH₃COOH | 100% | 100% | 100% |
| | NH₃ | 90% | 95% | 45% |
| removal efficiency | CH₃CHO | 40% | 60% | 3% |
| of third run | CH₃COOH | 100% | 100% | 100% |
| | NH₃ | 70% | 90% | 40% |

TNT have a larger specific surface area than titania (TiO₂) photocatalysts, and have both photocatalytic and adsorbing functions. The organic material adsorbed on the TNT may remain in strong contact with the TNT for a long time, and thus, may be effectively oxidized photocatalytically by the TNT. This oxidation mechanism following adsorption may remarkably facilitate removal of the organic material by the TNT. The organic material desorbed from zeolite is re-adsorbed onto TNT due to the adsorbing function of the TNT. Since the zeolite and TNT are adjacent to each other, the organic material desorbed from the zeolite is likely to re-adsorb onto the TNT, rather than be in free form in the air. The organic material re-adsorbed onto the TNT is oxidized due to the photocatalytic function of the TNT. Therefore, the filter materials and filters of the present disclosure may highly effectively remove organic materials in the air.

While the present general inventive concept has been particularly shown and described with reference to exemplary embodiments thereof, it will be understood by those of ordinary skill in the art that various changes in form and details may be made therein without departing from the spirit and scope of the present general inventive concept as defined by the following claims.

What is claimed is:

1. A filter material comprising a titania nanotube, zeolite, and a binder.

2. The filter material of claim 1, wherein the titania nanotube is obtained by subjecting titania powder to a hydro-thermal process using an alkali solution, an acid treatment, and calcination.

3. The filter material of claim 1, wherein the zeolite is a mordenite framework inverted (MFI)-type zeolite.

4. The filter material of claim 1, wherein the zeolite has a Si/Al mole ratio of from about 20 to about 100.

5. The filter material of claim 1, wherein the binder is bentonite, alumina, silica, apatite, or a combination thereof.

6. The filter material of claim 1, wherein the filter material is a layered filter material including a plurality of layers with different content ratios of the titania nanotube to the zeolite.

7. A filter comprising a filter support and a filter material layer coated on a surface of the filter support, wherein the filter material layer comprises a titania nanotube, zeolite, and a binder.

8. The filter of claim 7, wherein the filter support is a cordierite.

9. A filter comprising a filter support and a filter material layer coated on a surface of the filter support, wherein the filter material layer comprises a first coating layer on the surface of the filter support, and a second coating layer on an external surface of the first coating layer, the first coating layer comprising zeolite and a binder, and the second coating layer comprising a titania nanotube and a binder.

10. The filter of claim 9, wherein the filter support is a cordierite.

11. The filter material of claim 1, wherein the TNT and zeolite has a ratio of about 3:7 to about 7:3 by weight.

12. The filter material of claim 6, wherein the pluraity of layer comprises a first layer and a thrid layer that have a a ratio of about 7:3 to about 5:5 by weight and a second layer has a ratio of about 5:5 to about 3:7 by weight located between the first and thrid layers.

13. The filter of claim 7, wherein the filter materaial further comprises the TNT and zeolite has a ratio of about 3:7 to about 7:3 by weight.

14. The filter of claim 7, wherein the filter material further comprises a pluraity of layers, wherein a first layer and a thrid layer that have a a ratio of about 7:3 to about 5:5 by weight and a second layer has a ratio of about 5:5 to about 3:7 by weight located between the first and thrid layers.

15. A filter material comprising a titania nanotube, zeolite, and a binder, wherein the TNT and zeolite has a ratio of about 3:7 to about 7:3 by weight.
